(19) United States
(12) Patent Application Publication
(10) Pub. No.: US 2025/0069524 A1
(43) Pub. Date: Feb. 27, 2025

(54) Marking Units Disposed on a Tape Roll

(71) Applicant: Steven Cannon, Chapel Hill, NC (US)

(72) Inventor: Steven Cannon, Chapel Hill, NC (US)

(21) Appl. No.: 18/943,145

(22) Filed: Nov. 11, 2024

Related U.S. Application Data
(63) Continuation-in-part of application No. 17/902,121, filed on Sep. 2, 2022.
Application No. 17/902,121 is a continuation of application No. 63/395,648, filed on Aug. 5, 2022.

(51) Int. Cl. G09F 3/02

(52) U.S. Cl. CPC G09F 3/02; G09F 2003/0229

(57) ABSTRACT

A roll of similar marking units provides a way to mark direction of flow, issues, etc., by various parties. The marking units have a bottom with a non-adhesive surface extending between first and second adhesive surfaces. The front of the marking units preferably have first and second angled segments extending from opposing sides to a point. The back of the marking units preferably has third and fourth angled segments meeting at an internal corner. Adjacent units preferably contact one another on the roll and are separated a when pulling the end unit off of the roll.

### CLAIM OF PRIORITY

This application is a continuation in part of U.S. patent application Ser. No. 17/902,121 filed Sep. 2, 2022, which claims the benefit of U.S. Provisional Patent Application No. 63/395,648 filed Aug. 5, 2022, both of which are incorporated herein by reference in its entirety.

### FIELD OF THE INVENTION

The present invention relates to arrow or chevron shaped adhesive backed pointers or markers sequentially disposed about a roll providing arrow or marking segments, particularly well adapted to serve as adhesive indicators for various uses and be applied potentially independently of specially designed dispensers.

### BACKGROUND OF THE INVENTION FIELD OF THE INVENTION

U.S. Pat. No. 4,008,682 teaches the construction and use of a tape dispenser that cuts strip tape of a specific width into arrow shapes having points at one end extending away from the tape and corresponding internal points at the other with two opposing triangles at the edges of the tape (the points are at edges). A portion of the tape is then apparently not moistened so that a center strip of the tape segment can relatively easily be handled to apply the tape, while also assisting in the removal of the tape.

Masking tape, and other tape has been provided in roll form for years.

In the construction industry, it is not unusual to employ a pad of sticky notes (rectangles having an adhesive strip toward one edge) to place near imperfections, such as in paint or drywall to identify issues for someone to address or touch up. While sometimes effective, other times, it may be difficult to identify a specific imperfection relative to the rectangular shape of the sticky note in the absence of any other indicia.

The applicant believes that there is a need for improved arrow or chevron shaped indicators for use in various fields.

### SUMMARY OF THE INVENTION

It is an object of many embodiments of the present invention to provide an improved adhesive indictor.

It is another object of many embodiments of the present invention to provide an improved adhesively applied pointer.

It is an object of many embodiments of the present invention to provide a roll of adhesively applied pointers.

It is an object of many embodiments of the present invention to provide a roll of adhesively applied arrow shaped portions having bottoms with at least portions that are adhesive.

Accordingly, the applicant has developed a tape-based product preferably having first and second adhesive spaced apart portions along a bottom surface. The product preferably has two angled segments extending symmetrically relative to a center of the tape from the edges to an extending point at the center. The product also preferably extends from the first portion and has a recess formed of two angled segments extending from the edges, symmetrically toward the center of the tape to meet at an internal corner (which preferably corresponds to the point of the next first portion). First portion of a first product may be die cut relative to a second portion of a second product.

The arrow or chevron marker may be utilized to point at a specific issue that is desired to be addressed, like a paint issue or drywall imperfection, to identify a direction of fluid flow, or for various other uses to potentially provide information or direct someone's attention to something. Different color tapes may be utilized within certain fields to identify different situations.

The first and second adhesive portions are preferably parallel to one another and extend from towards an outer edge of the product toward the center, of not from the outer edge towards the center. The non-adhesive portion may be symmetrically disposed about a centerline of the product. The adhesive portions also may be symmetrically disposed relative to the centerline.

Because the non-adhesive portion is along the centerline with the tip of the arrow, a user may easily remove the arrow when desired by pulling at the tip of the arrow.

### BRIEF DESCRIPTION OF THE DRAWINGS

The particular features and advantages of the invention as well as other objects will become apparent from the following description taken in connection with the accompanying drawings in which:

FIG. 1 is top plan view of a first embodiment of a marker unit removed from a roll;

FIG. 2 is a bottom plan view of the unit of FIG. 1;

FIG. 3 is a perspective view of a roll of tape comprised of the units of FIGS. 1 and 2;

FIG. 4 is a perspective view of a manufacturing step die cutting arrow heads and tails into a sheet roll; and

FIG. 5 is a perspective view of a subsequent manufacturing step cutting individual rolls like FIG. 3 from the sheet roll.

### DETAILED DESCRIPTION OF THE PREFERRED EMBODIMENTS

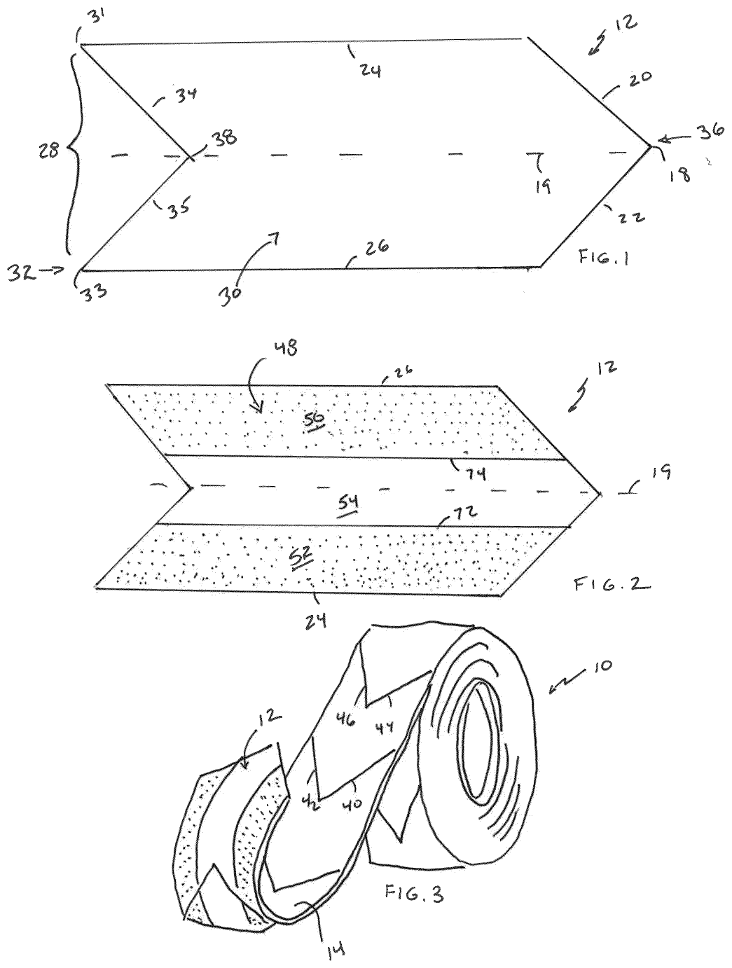

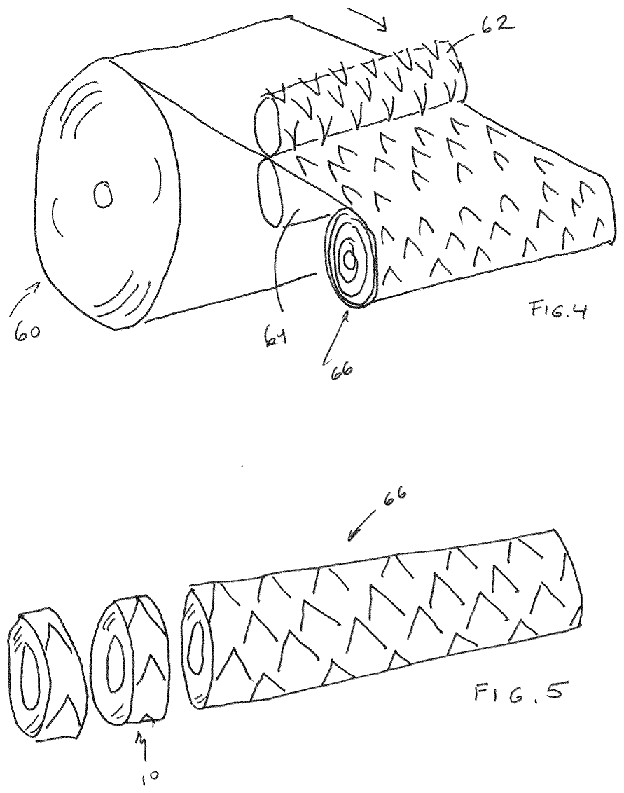

FIG. 3 shows a first embodiment of a tape roll 10 having successive tape marker units 12,14 such as shown with respect to exemplary marker unit 12 in FIGS. 1 and 2 which can be removed from the roll 10 individually, or in multiples to provide a longer chevron or arrow shape as will be explained in detail below.

Each marker unit 12,14, etc., may have an extending point 18, such as at center line 19 of marker units 12,14. The point 18 may be the intersection of first and second angled segments 20,22 which extend from side edges 24,26 of marker unit 12 and preferably meet at extending point 18. Between side edges 24,26 is the width 28 of the marker unit 12. FIG. 1 shows the top 30 of a marker unit 12.

The marker unit 12 preferably extends rearwardly of the point 18 has third and fourth angled segments 34,35 beginning at edges 24,26 and meet at an internal corner 38. The internal corner 38 is an angle as are the first and second points 31,33 at the edges 24,26. The points 31,33 are preferably at an end 32. Edges 24,26 could round off (i.e., not be pointed) to connect to third and fourth angled segments 34,35 as well as to first and second angled segments 20,22. Segments 20,22 and 34,35 need not necessarily be linear for all embodiments. Point 18 does not necessarily require linear segments defining a specific angle for all embodiments, but could be a a forward termination of the marker unit 12.

Die cuts 40,42,44,46, and others, may separate one marker unit 12,14 from one another. A bottom 48 of a marker unit 12 is shown in FIG. 2 having a first adhesive portion 50. A second adhesive portion 52 is spaced from the first adhesive portion 50 by a non-adhesive portion 54. The non-adhesive portion preferably extends from a front 36 towards an end 32 of the marker unit, such as from point 18 to corner 38 and may be symmetrically disposed about centerline 19. First and second adhesive portions 50,52 are preferably parallel to one another (and/or the non-adhesive portion 52) and/or symmetrically disposed relative to centerline 19 for at least some embodiments. First and second adhesive portions 50,52 preferably extend from the non-adhesive portion 54 toward the edges 26,24, respectively, if not to the edges 26,24 for at least some embodiments.

The first and second adhesive portions 50,52 preferably have internal edges 72,74 which define the outer edges of non-adhesive portion 54 for many embodiments. Internal edges 72,74 are preferably linear and possibly parallel to one another and/or are symmetrical relative to centerline 19. Internal edges 72 and 74 preferably extend from first angled surface 20 to third angled surface 34 and from second angled surface 22 to fourth angled surface 35, respectively.

In order to construct the roll 10 of FIG. 3, manufacturing steps of a preferred method of manufacturing are shown in FIGS. 4 and 5. Specifically a roll sheet 60 may be directed along a roll or kiss-cut die cutter 62, possibly opposite a roll 64 to apply an offset tip and tail cutting pattern as seen in the figures to provide a die cut log 66. Die cut log 66 may then be cut into individual rolls 10 as seen in FIG. 5 and in detail in FIG. 3. Rolls 10 may then be further processed, such as by placing in packaging as would be understood by those of ordinary skill in the art. The roll sheet 60 is preferably provided with adhesive portions 50,52 spaced apart by non-adhesive portions 54 which may be accomplished with rollers applying rows of spaced apart adhesive as would be understood by those of ordinary skill in the art.

In use, one marker unit 12,14 is removed from the others and applied as desired, such as to mark direction of flow, whether it be traffic, fluid or other flow. Other uses include marking issues to address such as paint issues or sheetrock imperfections. A particular user may utilize one color for one purpose and another color for another (blue for paint, yellow for sheetrock, etc.). Thus, a contractor, or other party, could walk through an almost complete construction and identify issues for a punch out person to address before a final walk-through inspection by a purchaser, etc. Other parties could use in similar or dissimilar ways. Teachers could use to assist in grading tests. Lawyers could use to identify where to sign a document. The applicant has not even begun to identify all of the potential uses of marker units 12,14, when separated from the roll 12, but is very excited about the prospects.

The sheet material, used to manufacture the sheet roll 60, may be varied, as well as the type of adhesive to provide adhesive portions 50,52, to accommodate the user, according to a specific surface and/or if there is a specific environmental requirement of the product. For instance, environments may include moist or dry and dusty environments. The length of time the marker units 12,14 are intended to be applied in a situation may also be a factor, such as when a longer period of time is contemplated, might affect the adhesive utilized or material integrity of much of the tape 40. Some embodiments may contemplate a situation where the tape 10, has a possible use underwater. Higher or lower than normal temperatures may be present and addressed with these or still other embodiments. This patent makes no guarantees, that various embodiments will work in some of these unusual conditions, however, the tape manufacturer, may develop new materials and adhesives, to achieve these new goals, and/or employ existing materials, adhesives and technology to achieve many of the objectives and effects of various embodiments discussed herein.

Some presently preferred embodiments are fabricated with no perforations separating adject marker units 12,14, no release liners and/or no necessary dispensers.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

1. A roll of marker units comprising:
adjacently connected marker units wound to form a roll, said marker units having a top and bottom with opposing side edges defining a width, a centerline defined between the opposing edges;
a point extends from a front of the marker units;
wherein the bottom of the marker units further comprises (a) a non-adhesive portion extending intermediate the opposing edges and includes the point; and (b) first and second adhesive portions spaced apart by the non-adhesive portion.

2. The roll of claim 1 wherein the marking units have first and second segments extending from the opposing side edges toward the point.

3. The roll of claim 2 wherein the marking units have third and fourth segments meeting at an internal corner; and
said first and third segments of adjacent marker units initially contacting one another; and said second and fourth segments of adjacent marker units initially contacting one another on the roll.

4. The roll of claim 1 wherein the first and second adhesive portions are parallel to one another.

5. The roll of claim 1 wherein the first and second adhesive portions extend from the non-adhesive portion toward the opposing edges.

6. The roll of claim 5 wherein the first and second adhesive portions extend to the opposing edges from the non-adhesive portion.

7. The roll of claim 1 wherein the first and second portions are similarly shaped.

8. The roll of claim 1 wherein the first and second angled segments are linear from the opposing side edges to the point.

9. A roll of marker units comprising:
adjacent similarly constructed marker units wound about a roll, said marker units having a top and a bottom and side edges defining a width therebetween and being symmetrically disposed relative to a centerline, first and second segments extending from the opposing side edges to a point;
a non-adhesive portion extending along a centerline and the point along the bottom of the marker units bounded by first and second adhesive portions extending from the non-adhesive portions towards the side edges.

10. The roll of claim 9 wherein the marker units have third and fourth angled segments meeting at an internal corner.

11. The roll of claim 10 wherein the internal corner of a first marker unit contacts a point of a second marker unit on the roll.

12. The roll of claim 10 wherein the first adhesive portion extends from the first to the third angled segment.

13. The roll of claim 12 wherein the second adhesive portion extends from the second to the fourth angled segment.

14. The roll of claim 9 wherein adjacent marker units are die cut relative to one another.

15. The roll of claim 9 wherein the first and second adhesive portions are parallel to one another.

16. The roll of claim 15 wherein the first and second adhesive portions extend from the non-adhesive portion toward the side edges.

17. The roll of claim 16 wherein the first and second adhesive portions extend to the side edges.
